(19) United States
(12) Patent Application Publication
(10) Pub. No.: US 2016/0001626 A1
(43) Pub. Date: Jan. 7, 2016

(54) METHOD FOR ADJUSTING A ROLL MOMENT OF AN AXLE OF A VEHICLE FOR ROLL STABILIZATION

(71) Applicant: Dr. Ing. h.c. F. Porsche Aktiengesellschaft, Stuttgart (DE)

(72) Inventors: Igor ILLG, Renningen (DE); Thomas MIRWALDT, Stuttgart (DE)

(21) Appl. No.: 14/789,348

(22) Filed: Jul. 1, 2015

(30) Foreign Application Priority Data
Jul. 3, 2014 (DE) 102014109318.6

(51) Int. Cl. B60G 21/055

(52) U.S. Cl. CPC B60G 21/055; B60G 2200/464; B60G 2202/135; B60G 2202/442; B60G 2800/012

(57) ABSTRACT

A method for adjusting a roll moment of an axle of a vehicle for roll stabilization of a body of the vehicle, wherein the axle has two stabilizers which are operatively connected to in each case one wheel suspension system of the vehicle body, wherein an actuator is provided which is operatively connected to the two stabilizers, wherein an angular position for at least one stabilizer is determined depending on a setpoint roll moment of the axle and depending on angular positions of the two stabilizers, and wherein the actuator turns the at least one stabilizer to the determined angular position.

### CROSS-REFERENCE TO RELATED APPLICATION

This application claims priority under 35 U.S.C. §119 of German Patent Application No. 10 2014 109 318.6, filed Jul. 3, 2014, which is incorporated by reference herein in its entirety.

### BACKGROUND

The invention relates to a method for adjusting a roll moment of an axle of a vehicle for roll stabilization of a body of the vehicle. The driving behavior of a motor vehicle is determined by a large number of forces and moments which act on the motor vehicle in the direction of vehicle axes, specifically in the direction of a longitudinal axis, a transverse axis, a vertical axis and a roll axis. The roll axis is understood to be an axis which extends through the roll centers of the front axle and rear axle of the motor vehicle. A rolling movement of the motor vehicle about the roll axis is called rolling.

In order to achieve a good driving behavior of a motor vehicle, it is known to carry out roll stabilization on a motor vehicle, wherein, in the event of roll stabilization on the basis of the vehicle position, characterized by, for example, a measured transverse acceleration of the motor vehicle or a calculated transverse acceleration of the motor vehicle, actuating signals are provided for actuators which are associated with the front axle and the rear axle of the motor vehicle and which provide supporting moments to the wheel suspension systems at the front axle and/or at the rear axle for roll stabilization. One objective of roll stabilization is to achieve as horizontal a position of the vehicle body during driving, including when travelling around corners, as possible.

DE 10 2008 024 092 A1, which is incorporated by reference herein, discloses a method for roll regulation for a divided motor vehicle stabilizer. According to the described method for roll regulation at a front and/or rear axle of a motor vehicle, having a divided stabilizer, an electromechanical actuator compensates for roll movements of the vehicle structure in relation to the chassis by bracing the two stabilizer parts against one another in both directions of rotation of the actuator such that the vehicle structure is held as parallel to a horizontal plane as possible by a controller prespecifying the respectively required actuator torque, which is to be applied by the actuator, as the setpoint torque. A limit transverse acceleration of a specific magnitude is stored in the controller and, when said limit transverse acceleration is reached, the actuator torque is no longer prespecified by the controller for bracing the stabilizer parts against one another, but rather maintaining a constant rotation angle of the actuator which is prespecified by the controller, in particular the currently existing rotation angle, serves as the setpoint variable for the actuator. In order to make the transition from the setpoint variable actuator rotation angle to the setpoint variable actuator torque, as the transverse acceleration decreases, the actuator is changed over by the controller from maintaining the angle for position regulation to prespecifying the torque by torque regulation precisely when the currently existing torsion moment between the two stabilizer parts corresponds to the setpoint torque of the actuator which is calculated by the controller.

### SUMMARY

An object of the invention is to provide an improved method for adjusting a roll moment of an axle of a motor vehicle for roll stabilization.

An object of the invention is achieved by wherein the axle has two stabilizers which are operatively connected to in each case one wheel suspension system of the vehicle body, wherein an actuator is provided which is operatively connected to the two stabilizers, wherein an angular position for at least one stabilizer is determined depending on a setpoint roll moment of the axle and depending on angular positions of the two stabilizers, and wherein the actuator turns the at least one stabilizer to the determined angular position.

Further advantageous embodiments of the invention are specified in the detailed description and the claims that follow.

One advantage of the described method is that the inclination of the body of the vehicle to roll is adjusted more precisely. This is achieved by the angular positions of the two stabilizers being taken into account in order to determine the value for the desired angular position of at least one stabilizer. As a result, the current rotation position of a stabilizer is taken into account. Therefore, the inclination of the vehicle body to roll can be adjusted in a more precise and more accurate manner.

A further embodiment of the method has the advantage that the inclination to roll is adjusted even more precisely. This is achieved in that at least an initial angle of one stabilizer is taken into account in order to determine the value of the angular position of the at least one stabilizer. The desired roll stabilization can be determined in a precise manner in this way.

Depending on the selected embodiment, at least the initial angles of the two stabilizers of the axle are taken into account. The method is further improved as a result.

In addition, the desired angular position for the two stabilizers of the axle is determined in a further embodiment. In this way, a roll moment can be exerted onto both wheel suspension systems in order to achieve the desired roll stabilization of the vehicle body.

In a further embodiment, the actuator is connected to one of the stabilizers by means of at least one torsion spring. Depending on the selected embodiment, the actuator is connected to one of the two stabilizers by means of in each case one torsion spring. The torsion spring provides a resilient torsion moment between the stabilizers and the actuator. Roll stabilization is improved in this way.

In a further embodiment, at least one vertical position of a wheel, preferably the vertical positions of the wheels of one axle, is/are taken into account when determining the desired angular position for the at least one stabilizer. Improved roll stabilization can be achieved in this way.

In a further embodiment, a steering angle of a steering axle is taken into account when determining the desired angular position for the at least one stabilizer. Roll stabilization is further improved as a result too.

In a further embodiment, a roll rate of the body of the vehicle and/or an acceleration of at least one wheel and/or an acceleration of the vehicle body about a longitudinal axis and/or an acceleration of the vehicle body about a transverse axis are/is taken into account when determining the desired angular position for the at least one stabilizer. Roll stabilization can be further improved as a result.

### BRIEF DESCRIPTION OF THE DRAWINGS

The invention will be explained in greater detail below with reference to the figures, in which

FIG. 1 is a schematic illustration of a motor vehicle having a chassis,

FIG. 2 is a schematic illustration of an axle of the chassis, and

FIG. 3 is a schematic illustration of the program sequence for carrying out the method.

### DETAILED DESCRIPTION

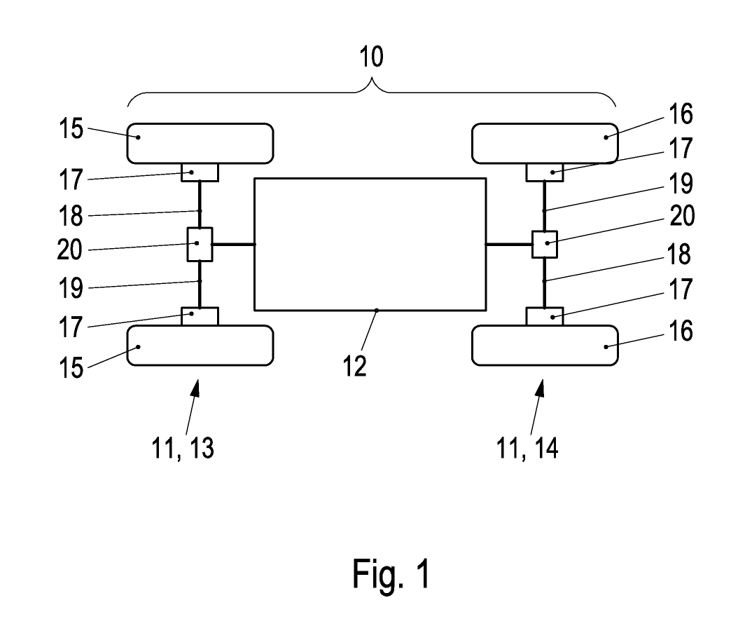

FIG. 1 shows, in a schematic illustration, a motor vehicle 10 which has a chassis 11 and a vehicle body 12. A front axle 13 and a rear axle 14 of the chassis 11 are illustrated, wherein the front axle 13 has front wheels 15, and the rear axle 14 has rear wheels 16.

The front wheels 15 and the rear wheels 16 are each fitted to wheel suspension systems 17, wherein a first and a second stabilizer 18, 19 extend between the wheel suspension systems 17 for the front wheels 15. An actuator 20 is arranged between the two stabilizers 18, 19. In the same way, in each case a first and a second stabilizer 18, 19 extend between the wheel suspension systems 17 of the rear wheels 16, wherein an actuator 20 is arranged between the stabilizers 18, 19. The actuators 20 can have electrical, hydraulic and/or piezoelectric elements.

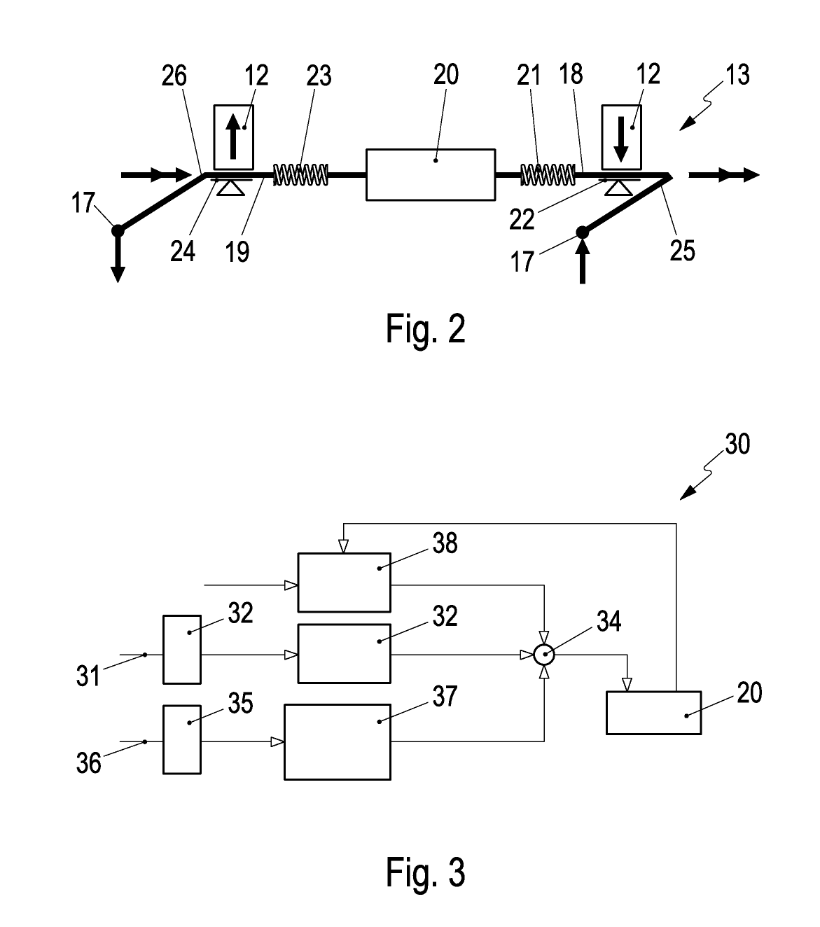

FIG. 2 shows, in a schematic enlarged illustration, the structure of the front axle 13. The rear axle has the same structure. In the illustrated exemplary embodiment, the actuator 20 is operatively connected to the first stabilizer 18 by means of a first torsion spring 21. The first stabilizer 18 is fastened to the vehicle body 12 in a rotatable manner by means of a first bearing 22. In addition, one end of the first stabilizer 18 is operatively connected to the wheel suspension system 17. Depending on the rotation position of the first stabilizer 18, the vertical position of the wheel suspension system 17 is changed in relation to the vehicle body 12. A front wheel is rotatably mounted on the wheel suspension system 17. Depending on the selected embodiment, the first torsion spring 21 can also be dispensed with and the actuator 20 can be connected directly to the first stabilizer 18.

The actuator 20 is additionally connected to the second stabilizer 19 by means of a second torsion spring 23. The second stabilizer 19 is fastened to the vehicle body 12 in a rotatable manner by means of a second bearing 24. One end of the second stabilizer 19 is operatively connected to a second wheel suspension system 17. Depending on the rotation position of the second stabilizer 19, a vertical position of the second wheel suspension system 17 is changed in relation to the vehicle body 12. A second front wheel is rotatably mounted on the second wheel suspension system 17. The first and the second stabilizer 18, 19 have an angled portion 25, 26 between the respective bearing 22, 24 and the end of the stabilizer or the associated wheel suspension system. On account of the angled portion 25, 26, rotation of the stabilizers 18, 19 leads to a change in the vertical position of the wheel suspension systems 17.

The actuator 20 is designed to exert a roll moment-forming force on the vehicle body 12 and the wheel suspension systems 17 by means of rotation of the first and/or of the second stabilizer 18, 19. Depending on the selected embodiment, the two stabilizers 18, 19 can be rotated in the same direction and at the same time by the actuator 20, so that the wheel suspension system of the first stabilizer 18 is subject to, for example, a roll moment-forming force upward in the direction of the vehicle body 12, while the wheel suspension system of the second stabilizer 19 is subject to a roll moment-forming force downward away from the vehicle body 12. In addition, it is possible for only one stabilizer 18, 19 to be turned to the angular position, depending on the selected embodiment. The actuator 20 can be designed in the form of a controlled-angle actuating unit.

FIG. 3 shows, in a schematic illustration, a controller 30 for carrying out roll stabilization of the motor vehicle. The controller 30 detects, by means of sensor inputs 31, a state of operation of the vehicle, in particular a transverse acceleration of the vehicle, and from this determines, in a first program block 32, a setpoint roll moment for a front axle and/or a rear axle of the motor vehicle for roll stabilization of the vehicle body in order to counteract a roll moment on the vehicle body which is caused by the state of operation of the vehicle. To this end, corresponding characteristic curves and/or calculation methods are stored in the memory of the controller.

The setpoint roll moment of the front axle and/or the rear axle is converted by means of a second program block 32, for example with the aid of an elastokinematic transformation calculation, into a moment-forming stabilizer angle of the first stabilizer 18 and/or of the second stabilizer 19 of the front axle, and passed on to an adding unit 34.

The stabilizer moment SM is calculated from a constant stiffness CF of the torsion spring multiplied by the angular position P of the actuator. In addition, the difference DP between the angular positions of the stabilizers and/or an initial angle IP of the stabilizers can be taken into account when calculating the stabilizer moment. By way of example, the following formula can be used: SM=(IP+P−DP)*CF.

This formula can be used in order to calculate the angular position of the actuator depending on the desired setpoint roll moment.

Furthermore, the controller 30 has a third program block 35 which detects, by means of a second sensor input 36, vertical positions of the wheels of the front axle, a roll rate of the vehicle body, wheel accelerations of the front wheels, and a structure acceleration of the vehicle body. This data is passed on to a fourth program block 37. In the fourth program block 37, the vertical positions and/or roll rate and/or wheel accelerations and/or structure acceleration are subjected to an elastokinematic transformation and preferably filtering in order to determine a difference between the angular positions of the first and the second stabilizer 18, 19. The difference between the angular positions of the stabilizers 18, 19 is fed to the adding unit 34. In a first embodiment, the adding unit 34 determines a setpoint actuator angle from the moment-forming stabilizer angle and the difference angle between the stabilizers. The controller 30 passes the setpoint actuator angle to the controlled-angle actuator 20.

In a further embodiment, a fifth program block 38 is provided. The fifth program block 38 detects vertical positions of the wheels and/or a steering angle of a steering device of the front axle and/or a structure acceleration and/or wheel accelerations of the front wheels and from this/these determines an initial angle, preferably taking into account the setpoint actuator angle and/or the actual actuator angle. The initial angle represents the angle of the stabilizer which the stabilizer is at in a moment-free state of the axle.

The initial angle is fed to the adding unit 34. In this embodiment, the adding unit 34 takes into account not only the moment-forming stabilizer angle and the difference angle of the stabilizers, but also the initial angle, in order to determine the setpoint actuator angle depending on a prespecified calculation method. The calculation method can be stored in the form of a table, a characteristic curve, a characteristic map and/or a formula. The adding unit 34 passes the correspondingly determined setpoint actuator angle to the actuator 20.

The actuator 20 adjusts the stabilizers 18, 19 to the corresponding angular position depending on the prespecified setpoint actuator angle for the first and the second stabilizer 18, 19.

Depending on the selected embodiment, the first program block 32 can determine only the moment-forming stabilizer angle of one of the two stabilizers 18, 19. In addition, the first program block 32 can determine the moment-forming stabilizer angles of the two stabilizers 18, 19. Accordingly, the setpoint actuator angle for the first and/or for the second stabilizer 18, 19 is passed on to the actuator 20 by the adding unit 34. Analogously, the actuator 20 changes the angular position of the first and/or of the second stabilizer 18, 19 in accordance with the prespecified setpoint actuator angle or angles.

Depending on the selected embodiment, the first program block 32, the fourth program block 37 and/or the fifth program block 38 can take into account a vertical position of at least one wheel of the front axle and/or a steering angle of a steering axle of the vehicle and/or a roll rate of the body of the vehicle and/or an acceleration of at least one wheel and/or an acceleration of the vehicle body about a longitudinal axis and/or about a transverse axis when determining the desired angular position, that is to say when determining the moment-forming stabilizer angle, when determining the angular difference between the stabilizers and/or when determining the initial angle.

### LIST OF REFERENCE SYMBOLS

10 Motor vehicle
11 Chassis
12 Vehicle body
13 Front axle
14 Rear axle
15 Front wheels
16 Rear wheels
17 Wheel suspension system
18 First stabilizer
19 Second stabilizer
20 Actuator
21 First torsion spring
22 First bearing
23 Second torsion spring
24 Second bearing
25 First angled portion
26 Second angled portion
30 Controller
31 First sensor input
32 First program block
33 Second program block
34 Adding unit
35 Third program block
36 Second sensor input
37 Fourth program block
38 Fifth program block

1. A method for adjusting a roll moment of an axle of a vehicle for roll stabilization of a body of the vehicle, wherein the axle has two stabilizers which are operatively connected to in each case one wheel suspension system of the vehicle body, wherein an actuator is provided which is operatively connected to the two stabilizers, comprising the steps of determining a desired angular position for at least one stabilizer depending on a setpoint roll moment of the axle and depending on angular positions of the two stabilizers, and turning the at least one stabilizer to the determined angular position via the actuator.

2. The method as claimed in claim 1, wherein at least an initial angle of one stabilizer is taken into account in order to determine the value of the angular position of the at least one stabilizer, wherein an angular position of the stabilizer corresponds to the initial angle in a moment-free state of the stabilizer.

3. The method as claimed in claim 2, wherein at least an initial angle of the second stabilizer is taken into account in order to determine the value of the angular position of the at least one stabilizer.

4. The method as claimed in claim 1, wherein the desired angular positions are determined by the two stabilizers, and the stabilizers are rotated by the actuator in accordance with the desired angular positions.

5. The method as claimed in claim 1, wherein the actuator is operatively connected to at least one of the stabilizers by means of at least one torsion spring.

6. The method as claimed in claim 1, wherein at least one vertical position of a wheel is taken into account when determining the desired angular position for the at least one stabilizer.

7. The method as claimed in claim 1, wherein a steering angle of a steering axle is taken into account when determining the desired angular position for the at least one stabilizer.

8. The method as claimed in claim 1, wherein a roll rate of the body of the vehicle and/or at least one acceleration of a wheel and/or an acceleration of the vehicle body about a longitudinal axis and/or an acceleration of the vehicle body about a transverse axis are/is taken into account when determining the desired angular position.

9. A controller for carrying out a method as claimed in claim 1.

10. The method as claimed in claim 5, wherein the actuator is connected to the two stabilizers by means in each case of the torsion spring.
